(19) United States
(12) Patent Application Publication
(10) Pub. No.: US 2022/0231588 A1
(43) Pub. Date: Jul. 21, 2022

(54) LINEAR VIBRATION MOTOR AND ELECTRONIC APPARATUS USING THE SAME

(71) Applicant: Murata Manufacturing Co., Ltd., Nagaokakyo-shi (JP)

(72) Inventor: Takeshi KURITA, Nagaokakyo-shi (JP)

(21) Appl. No.: 17/714,795

(22) Filed: Apr. 6, 2022

Related U.S. Application Data
(63) Continuation of application No. PCT/JP2020/043217, filed on Nov. 19, 2020.

(30) Foreign Application Priority Data
Nov. 29, 2019 (JP) 2019-217457
Dec. 26, 2019 (JP) 2019-235675
Jan. 31, 2020 (JP) 2020-014403
Nov. 2, 2020 (JP) 2020-183652

(51) Int. Cl. H02K 33/16; B06B 1/04

(52) U.S. Cl. CPC H02K 33/16; B06B 1/045

(57) ABSTRACT

A linear vibration motor is provided that includes a housing, a vibrator, a first shaft, and a second shaft. The vibrator vibrates along a first direction, and has a first through-hole and a space extending along the first direction. The first shaft and the second shaft, which are guides, are disposed along a second direction and are fixed to the housing so as to support the vibrator slidably along the first direction. In the linear vibration motor, the first shaft is fitted together by insertion into the first through-hole, and the second shaft is inserted into the space. The second shaft and part of a wall determining the space are in contact with each other in a third direction.

### CROSS REFERENCE TO RELATED APPLICATIONS

The present application is a continuation of PCT/JP2020/043217 filed Nov. 19, 2020, which claims priority to each of Japanese Patent Application No. 2019-217457, filed Nov. 29, 2019, Japanese Patent Application No. 2019-235675, filed Dec. 26, 2019, Japanese Patent Application No. 2020-014403, filed Jan. 31, 2020, and Japanese Patent Application No. 2020-183652, filed Nov. 2, 2020, the entire contents of each of which are incorporated herein by reference.

### TECHNICAL FIELD

The present disclosure relates to a linear vibration motor and an electronic apparatus using the same.

### BACKGROUND

An example of a linear vibration motor is described in U.S. Patent Application Publication No. 2016/0226361 (hereinafter “Patent Document 1”). FIG. 22 is a disassembled perspective view of the linear vibration motor described in Patent Document 1. As shown, a linear vibration motor 300 includes a housing 301, a vibrator 302, a first guide 303, a second guide 304, and a coil 305. The vibrator 302 includes a first magnet M301, a second magnet M302, and a third magnet M303. Moreover, a fourth magnet M304 and a fifth magnet M305 are fixed to the housing 301.

The vibrator 302 vibrates along a first direction D1 by the coil 305, the first magnet M301 serving as a driving magnet, and the first guide 303 and the second guide 304 that guide the movement of the vibrator 302. The second magnet M302 and the fourth magnet M304 are disposed along the first direction D1 to repel each other, and the third magnet M303 and the fifth magnet M305 are disposed along the first direction D1 to repel each other. That is, the second magnet M302 and the fourth magnet M304, and the third magnet M303 and the fifth magnet M305 constitute a magnetic spring mechanism for vibration of the vibrator 302 along the first direction D1.

By this magnetic spring mechanism, the vibration of the vibrator 302 is transferred to the housing 301 via the fourth magnet M304 and the fifth magnet M305, and is sensed as the vibration of the linear vibration motor 300.

In recent years, a linear vibration motor has been used as a vibration generator for skin sensory feedback or for confirming a key operation, an incoming call, or the like, by vibration in an electronic apparatus, such as a portable information terminal. In order to cause the linear vibration motor to generate sufficient vibration, it is necessary that the vibrator normally vibrates in one direction and unnecessary friction between the vibrator and a guide fixed to a housing is reduced.

For example, in the linear vibration motor 300 described in Patent Document 1, the vibrator 302 and each guide are engaged with each other with a protrusion provided on each side surface of the vibrator 302 fitting into a groove of each guide facing a corresponding one of the side surfaces. With this configuration, in a case where the dimensional accuracy of the width of the vibrator 302 is low and the width is shorter than the intended length, there is a possibility that the vibrator 302 rattles between the guides and the vibrator does not normally vibrate in one direction (that is, a first direction D1). Whereas, in a case where the width of the vibrator 302 is longer than the intended length, there is a possibility that the vibrator 302 is excessively pressed against each guide and unnecessary friction with each guide occurs.

### SUMMARY OF THE INVENTION

Accordingly, it is an object of the present disclosure to provide a linear vibration motor in which a vibrator can easily vibrate in one direction and unnecessary friction between the vibrator and a guide fixed to a housing may be reduced. Moreover, an electronic apparatus using the linear vibration motor is also provided in an exemplary aspect.

The present disclosure first focuses on a linear vibration motor. A first exemplary aspect of the linear vibration motor includes a housing, a vibrator, a first shaft, and a second shaft. The first shaft and the second shaft correspond to a guide fixed to the housing. The vibrator is accommodated in the housing, is configured to vibrate along a first direction, and has a first through-hole and a space each extending along the first direction. The first shaft and the second shaft are disposed along a second direction and are each fixed to the housing so as to slidably support the vibrator along the first direction.

In the first exemplary aspect of the linear vibration motor, the first shaft is fitted together by insertion into the first through-hole, and the second shaft is inserted into the space. The second shaft and part of a wall determining the space are in contact with each other in a third direction orthogonal to each of the first direction and the second direction.

A second exemplary aspect of the linear vibration motor includes, similarly to the first aspect, a housing, a vibrator, a first shaft, and a second shaft. In the second aspect of the linear vibration motor, the second shaft and part of the wall determining the space are in contact with each other with a second member containing a low-friction material in between in the third direction orthogonal to each of the first direction and the second direction.

The present disclosure also focuses on an electronic apparatus. The electronic apparatus according to the present disclosure includes the linear vibration motor according to the present disclosure and an apparatus housing. Moreover, the linear vibration motor is accommodated in the apparatus housing.

With the linear vibration motor according to the exemplary aspects of the present disclosure, a vibrator is configured to easily vibrate in one direction, and unnecessary friction between the vibrator and guides, that is, a first shaft and a second shaft, fixed to a housing is reduced. Further, the electronic apparatus according to the present disclosure is configured to generate vibration sufficient for skin sensory feedback and confirmation of a key operation, an incoming call, or the like since the linear vibration motor according to the present disclosure is used therein.

### BRIEF DESCRIPTION OF DRAWINGS

FIG. 1 is a perspective view of a linear vibration motor 100 illustrating a schematic form of the linear vibration motor according to the present disclosure.

FIG. 2 is a perspective view of the linear vibration motor 100 with a top plate portion 1d of a housing 1 thereof removed, placing a first shaft 3 on the front side.

FIG. 3 is a perspective view of the linear vibration motor 100 with the top plate portion 1d of the housing 1 thereof removed, placing a second shaft 4 on the front side.

FIG. 4(A) is a perspective view of a first member 2d included in a vibrator 2 of the linear vibration motor 100, FIG. 4(B) is a front view of the first member 2d, and FIG. 4(C) is a sectional view of the first member 2d in the direction of arrows, taken along a plane including a line A-A in FIG. 4(B).

FIG. 5 is a sectional view, corresponding to FIG. 4(C), schematically illustrating a change in the state of contact between the first member 2d and the second shaft 4 in a case where there is a variation in the width of the vibrator 2 in a second direction D2.

FIG. 6 is a sectional view, corresponding to FIG. 4(B), schematically illustrating a change in the state of contact between the first member 2d and the second shaft 4 in a case where the second shaft 4 is inclined relative to a first direction D1.

FIG. 7(A) is a front view of a first modification of the first member 2d, FIG. 7(B) is a front view of a second modification of the first member 2d, FIG. 7(C) is a front view of a third modification of the first member 2d, and FIG. 7(D) is a front view of a fourth modification of the first member 2d.

FIG. 8(A) is a perspective view of a fifth modification of the first member 2d, FIG. 8(B) is a front view of the fifth modification of the first member 2d, and FIG. 8(C) is a sectional view of the fifth modification of the first member 2d in the direction of arrows, taken along a plane including a line B-B in FIG. 8(B).

FIG. 9 is a perspective view of the vibrator 2 including a sixth modification of the first member 2d.

FIG. 10 is a perspective view, corresponding to FIG. 3, of a linear vibration motor 100A that is a first modification of the linear vibration motor 100.

FIG. 11(A) is a front view of a second member 7 in the linear vibration motor 100A, FIG. 11(B) is a sectional view of the second member 7 in the direction of arrows, taken along a plane including a line C-C in FIG. 11(A), and FIG. 11(C) is a sectional view, corresponding to FIG. 11(B), of a first modification of the second member 7 in the direction of arrows in the linear vibration motor 100A.

FIG. 12 is a front view of a second modification of the second member 7 in the linear vibration motor 100A.

FIG. 13 is a perspective view, corresponding to FIG. 3, of a linear vibration motor 100B that is a second modification of the linear vibration motor 100.

FIG. 14(A) is a front view of the second member 7 in the linear vibration motor 100B, FIG. 14(B) is a sectional view of the second member 7 in the direction of arrows, taken along a plane including a line D-D in FIG. 14(A), and FIG. 14(C) is a sectional view, corresponding to FIG. 14(B), of a first modification of the second member 7 in the direction of arrows in the linear vibration motor 100B.

FIG. 15 is a front view of a second modification of the second member 7 in the linear vibration motor 100B.

FIG. 16(A) is a perspective view of a third modification of the second member 7 in the linear vibration motor 100B, FIG. 16(B) is a front view of another form of the third modification of the second member 7, and FIG. 16(C) is a front view of still another form of the third modification of the second member 7.

FIG. 17 is a perspective view of the vibrator 2 in a state that a fourth modification of the second member 7 in the linear vibration motor 100B is fitted into a groove T formed on another side surface of a substrate 2a.

FIG. 18(A) is a perspective view of the fourth modification of the second member 7, FIG. 18(B) is a perspective view of a state that the fourth modification of the second member 7 is fitted into the groove T formed on the other side surface of the substrate 2a.

FIG. 19 is a perspective view of the vibrator 2 in a state that a fifth modification of the second member 7 in the linear vibration motor 100B is fitted into the groove T formed on the other side surface of the substrate 2a.

FIG. 20(A) is a perspective view of the fifth modification of the second member 7, FIG. 20(B) is a perspective view of a state in which the fifth modification of the second member 7 is fitted into the groove T formed on the other side surface of the substrate 2a.

FIG. 21 is a transparent perspective view of a portable information terminal 1000 that is a schematic form of the electronic apparatus according to the present disclosure.

FIG. 22 is an exploded perspective view of a conventional linear vibration motor 300 according to the background art.

### DETAILED DESCRIPTION OF EMBODIMENTS

Features of the present disclosure will be described with reference to the drawings. In the schematic forms and embodiments of the linear vibration motor to be described below, the same or common portions are denoted by the same reference signs in the drawings, and there may be a case where descriptions thereof are not repeated.

Schematic Form of Linear Vibration Motor—

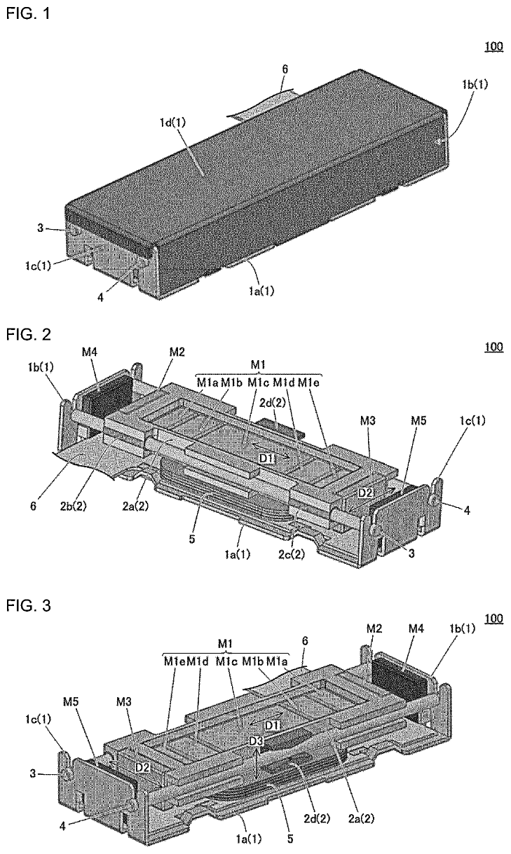

A linear vibration motor 100 exhibiting a schematic form of the linear vibration motor according to the present disclosure will be described with reference to FIG. 1 to FIG. 5.

FIG. 1 is a perspective view of the linear vibration motor 100. FIG. 2 is a perspective view of the linear vibration motor 100 with a top plate portion 1d of a housing 1 thereof removed, placing a first shaft 3 on the front side. FIG. 3 is a perspective view of the linear vibration motor 100 with the top plate portion 1d of the housing 1 thereof removed, placing a second shaft 4 on the front side.

As illustrated in FIG. 1 to FIG. 3, the linear vibration motor 100 includes the housing 1, a vibrator 2, the first shaft 3, the second shaft 4, a coil 5, an extended wiring member 6 connected to the coil 5, a fourth magnet M4, and a fifth magnet M5.

The housing 1 (from which the top plate portion 1d is removed) includes a bottom plate portion 1a extending in a first direction D1 to be described later, and a first side surface 1b and a second side surface 1c formed by bending the bottom plate portion 1a. That is, the bottom plate portion 1a, the first side surface 1b, and the second side surface 1c form a space in which the vibrator 2 is accommodated, and the top plate portion 1d serves as a lid member covering the space. The top plate portion 1d is in contact with each of the bottom plate portion 1a, the first side surface 1b, and the second side surface 1c. As a material of the housing 1, stainless steel, such as SUS304, may be used, for example. It is noted that the top plate portion and other portions may be made of different materials in alternative aspects.

In the linear vibration motor 100, the first side surface 1b and the second side surface 1c are formed by bending the bottom plate portion 1a at a right angle. The first shaft 3 and the second shaft 4 each extend along the first direction D1, and are disposed along a second direction D2 parallel to the bottom plate portion 1a and orthogonal to the first direction D1. As will be described later, the first shaft 3 and the second shaft 4 slidably support the vibrator 2 along the first direction D1. As a material of the first shaft 3 and the second shaft 4, stainless steel, such as SUS304, may be used, for example.

The first shaft 3 and the second shaft 4 are each fixed to bridge a space between the first side surface 1b and the second side surface 1c. It is noted that the method of fixing each shaft to the first side surface 1b and the second side surface 1c is not limited to the above. Further, each shaft may be fixed to a substrate 2a using a separate member, for example.

Furthermore, the fourth magnet M4 is fixed to the first side surface 1b such that the array direction of the magnetic poles is parallel to the first direction D1, and the fifth magnet M5 is fixed to the second side surface 1c with the array direction of the magnetic poles as same as above. For fixing the fourth magnet M4 to the first side surface 1b and fixing the fifth magnet M5 to the second side surface 1c, an epoxy-based adhesive may be used, for example.

The housing 1 of the linear vibration motor 100 has a structure in which the surface orthogonal to each of the bottom plate portion 1a, the first side surface 1b, and the second side surface 1c is open as described above, but the shape is not limited thereto. For example, the housing 1 may have a sealed structure when the top plate portion is attached. It is noted that the housing 1 includes a fixing portion to fix the housing 1 in an electronic apparatus such as a portable information terminal, but the fixing portion is not illustrated (the same applies hereinafter).

As further shown, the vibrator 2 is accommodated in the space described above in the housing 1. The vibrator 2 includes the substrate 2a, a first sleeve 2b, a second sleeve 2c, and a first member 2d, as well as a first magnet M1, a second magnet M2, and a third magnet M3. In the linear vibration motor 100, the vibrator 2 is configured to vibrate along the first direction D1 when a driving force to be described later is applied, from the coil 5 to be described later, to the first magnet M1 serving as a driving magnet.

The substrate 2a has three protrusions on one side surface and two protrusions on another side surface, and has a rectangular parallelepiped shape extending in the first direction D1 to be described later. It is noted that the number and arrangement of the protrusions are not limited to those described above. Further, in the linear vibration motor 100, recesses, into which magnet for forming a magnetic spring mechanism to be described later are inserted, are each formed on one end surface and the other end surface of the substrate 2a. In the linear vibration motor 100, the recesses pass through from one main surface to another main surface of the substrate 2a, but the present invention is not limited thereto.

One of the two protrusions provided on one side surface of the substrate 2a is provided with a groove that matches the outer shape of the first sleeve 2b and extends along the first direction D1. The other of the two protrusions is provided with a groove that matches the outer shape of the second sleeve 2c and extends along the first direction D1. The first sleeve 2b and the second sleeve 2c are fixed by being fitted into the grooves of the respective protrusions. That is, in the linear vibration motor 100, the vibrator 2 has two through-holes (e.g., first through-holes) extending along the first direction D1 on the one side surface side. Note that the through-hole referred to here is not limited to the sleeve illustrated in FIG. 2, and may be an annular shape that has a short length along the first direction D1 in an alternative aspect. Further, part of the side surface of the through-hole may be open. Furthermore, the number of the through-holes forming the first through-hole is not limited to two in alternative aspects.

The protrusion disposed at the central portion of the one side surface and the two protrusions provided on the other side surface are each provided with a groove extending along the first direction D1 and having a shape that prevents each shaft from coming into contact with the protrusions. The first member 2d, which will be described in detail later, is fixed to the central portion of the other side surface of the substrate 2a.

The substrate 2a is also configured to function as a weight portion. The vibrator 2 may further include another weight portion different from the substrate 2a in an alternative aspect.

As the material of the substrate 2a and the other weight portion, tungsten (W) and an alloy containing the same, stainless steel such as SUS304, Al and an alloy containing the same, or the like may be used, for example. In order to increase the mass of the vibrator 2 and to transfer a large vibration to the housing 1 via the magnetic spring mechanism, it is preferable that the substrate 2a and the other weight portion be made of a material having large relative density such as tungsten (W).

A through-hole is provided in the central portion of the substrate 2a, and the first magnet M1 is inserted and fixed such that the first magnet M1 and the coil 5 (to be described later) face each other. For fixing the first magnet M1 to the substrate 2a, an epoxy-based adhesive is used, for example. Inserting each magnet into the through-hole makes it easy to fix the magnet to the substrate 2a. Further, the magnet may be fixed to the substrate 2a with high accuracy. It is noted that each of the magnets may be fixed to the substrate 2a without being inserted into the through-hole.

In the linear vibration motor 100, the first magnet M1 includes five magnets M1a, M1b, M1c, M1d, and M1e arrayed along the first direction D1, and these magnets are disposed in a Halbach array, for example. However, it is also noted that the configuration of the first magnet M1 is not limited to the above.

It is sufficient that the first magnet M1 serving as a driving magnet includes at least one magnet that can apply a driving force for vibration of the vibrator 2 from the coil 5, to be described later. In a case where the first magnet M1 forms the Halbach array, it is sufficient that the first magnet M1 includes an odd number of three or more magnets arrayed along the first direction D1. In the present disclosure, an array of driving magnets that concentrate a magnetic field, generated by driving magnets, between the driving magnets and a coil that drives the vibrator is broadly referred to as the Halbach array. Therefore, it is sufficient that the number of magnets forming the Halbach array is an odd number of three or more.

As a material of the first magnet M1, a Nd—Fe—B-based or a Sm—Co-based rare-earth magnet may be used, for example. It is noted that for the first magnet M1, it is preferable to use a Nd—Fe—B based rare-earth magnet that have strong magnetic force and is able to increase the driving force of the vibrator 2.

The second magnet M2 is inserted into and fixed to the recess of the one end surface of the substrate 2a such that the array direction of the magnetic poles is parallel to the first direction D1, and the second magnet M2 and the fourth magnet M4 fixed to the first side surface 1b of the housing 1 are disposed to face each other and magnetically repel each other. The third magnet M3 is inserted into and fixed to the recess of the other end surface such that the array direction of the magnetic poles is parallel to the first direction D1, and the third magnet M3 and the fifth magnet M5 fixed to the second side surface 1c of the housing 1 are disposed to face each other and magnetically repel each other.

For example, the centers of gravity of the second magnet M2, the third magnet M3, the fourth magnet M4, and the fifth magnet M5 are disposed on the same axial line parallel to the first direction D1 in plan view. It is noted that it is sufficient that the second magnet M2, the third magnet M3, the fourth magnet M4, and the fifth magnet M5 are disposed such that at least respective magnets partially overlap with each other when viewed from the first direction D1. The N-pole of the second magnet M2 and the N-pole of the fourth magnet M4 face each other, and the S-pole of the third magnet M3 and the S-pole of the fifth magnet M5 face each other.

With this configuration, the pair of the second magnet M2 and the fourth magnet M4 and the pair of the third magnet M3 and the fifth magnet M5 each form a magnetic spring mechanism for the vibration along the first direction D1 of the vibrator 2. For fixing the second magnet M2 and the third magnet M3 to the substrate 2a, an epoxy-based adhesive may be used, for example.

Inserting each magnet into each recess makes it easy to fix the magnet to the substrate 2a. Further, each magnet may be fixed to the substrate 2a with high accuracy. It is also noted that each magnet may be fixed to the substrate 2a without being inserted into the recess.

For the material of the second magnet M2, the third magnet M3, the fourth magnet M4, and the fifth magnet M5, a rare-earth magnet of a Nd—Fe—B-base or a Sm—Co-base, or the like may be used, for example. Moreover, for each magnet described above, it is preferable to use a Sm—Co-based rare-earth magnet having a small temperature change rate of magnetic force and capable of stably exhibiting a magnetic spring effect.

The coil 5 is formed by winding a conductor wire around a virtual winding axis. The coil 5 is fixed to the bottom plate portion 1a of the housing 1 such that the winding axis is parallel to the direction normal to the bottom plate portion 1a of the housing 1, that is, the winding axis is orthogonal to the first direction D1 and the second direction D2. In the linear vibration motor 100, the coil 5 has a rectangular shape with rounded corners when viewed from the winding axis direction.

As the coil 5, a coil obtained by winding a coated Cu wire having a diameter of 0.06 mm approximately 50 turns is used, for example. Moreover, the coil 5 is connected to a stabilized power supply via a power amplifier by the extended wiring member 6, such as a flexible substrate, on which a wiring pattern is printed. The coil 5 is configured to apply a driving force to the first magnet M1 so that the vibrator 2 is able to vibrate along the first direction D1 by being energized via the extended wiring member 6. In FIG. 2 and FIG. 3, the winding wire of the coil 5 is not illustrated.

When a current flows through the coil 5, because of an interaction with the magnetic field of the first magnet M1, Lorentz force in a direction orthogonal to each of the magnetic field direction and the current flow direction is applied to the coil 5. Whereas, since the coil 5 is fixed to the housing 1 (i.e., the bottom plate portion 1a), reaction force to the Lorentz force is applied to the first magnet M1. Therefore, the coil 5 applies, by energization, a driving force along the first direction D1 to the first magnet M1, and consequently to the vibrator 2. That is, the first magnet M1 functions as a driving magnet in the linear vibration motor 100.

As described above, when the coil 5 has a rectangular shape when viewed from the winding axis direction, the direction of the Lorentz force is more likely to be aligned in the first direction D1 than when the coil 5 has an annular shape. Therefore, the driving force along the first direction D1 applied to the vibrator 2 is increased, and this achieves a preferable performance.

According to the exemplary aspect, the vibrator 2 is engaged with the first shaft 3 and the second shaft 4 as to be described below. First, the engagement between the vibrator 2 and the first shaft 3 will be described. As described above, the first sleeve 2b is fixed to one of the two protrusions provided on the one side surface of the substrate 2a of the vibrator 2, and the second sleeve 2c is fixed to the other of the two protrusions provided on the one side surface of the substrate 2a.

In exemplary aspects, examples of the material for the first sleeve 2b and the second sleeve 2c include low-friction materials of a polyphenylene sulfide-base, an aromatic polyester base, which is a so-called liquid crystal polymer, a polyacetal-base, or the like, brass, Ni, or stainless steel such as SUS304. For purposes of this disclosure, the low-friction material refers to a material exhibiting dynamic friction coefficient of approximately 0.15 or less relative to carbon steel in a thrust type dynamic friction coefficient specified in JIS K7218.

The first shaft 3 is slidably fitted together by insertion into the first sleeve 2b and the second sleeve 2c. For purposes of this disclosure, “fit together by insertion” means that the first shaft 3 is inserted and fitted into each sleeve in a state that looseness is suppressed within accuracy determined by a dimensional tolerance. With this configuration, the vibration of the vibrator 2 is restricted along the first direction D1. It is also noted that the engagement between the vibrator 2 and the first shaft 3 is not limited to the above.

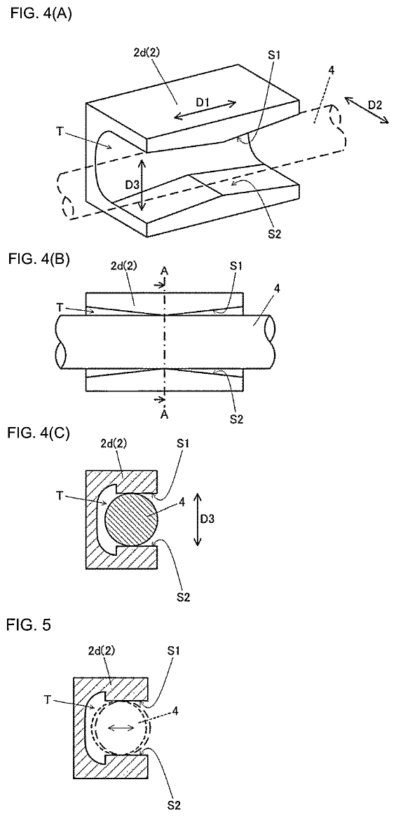

Next, the engagement between the vibrator 2 and the second shaft 4 will be described. As described above, the vibrator 2 includes the first member 2d fixed to the central portion of the other side surface of the substrate 2a. The first member 2d will be described in detail with reference to FIGS. 4(A)-(C) and FIG. 5.

FIG. 4(A) is a perspective view of the first member 2d included in the vibrator 2 of the linear vibration motor 100. FIG. 4(B) is a front view of the first member 2d. FIG. 4(C) is a sectional view of the first member 2d in the direction of arrows, taken along a plane including a line A-A in FIG. 4(B) and being orthogonal to the first direction D1. FIG. 5 is a sectional view corresponding to FIG. 4(C) schematically illustrating a change in the state of contact between the first member 2d and the second shaft 4 when there is a variation in the width of the vibrator 2 in the second direction D2. It is noted that in FIG. 4 and FIG. 5, the second shaft 4 is also illustrated so that the state of contact with the first member 2d may be understood.

In the linear vibration motor 100, a groove T opening in the second direction D2 is formed in the first member 2d in a state of being fixed to the other side surface of the substrate 2a. The groove T is deeper than the diameter of the second shaft 4 and extends along the first direction D1. The width of the groove T along a third direction D3 orthogonal to each of the first direction D1 and the second direction D2 increases from the central portion of the groove T toward the one end and the other end. It is noted that the change in the width of the groove T does not need to start from the central portion of the groove T, and may start from any portion inside the groove T. In other words, it is not necessary that the first member 2d is bilaterally symmetrical when viewed from the second direction D2.

That is, in the linear vibration motor 100, the vibrator 2 has a space on the other side surface side extending along the first direction D1. The length of the space becomes longer along the third direction D3 from the inside toward the one end and the other end. That is, in the first member 2d in FIG. 3, a protrusion of which height increases from the one end and the other end toward the central portion of the groove T is provided in the groove T.

It is noted that the sectional shape of the groove T may have various shapes as indicated in modifications to be described later in alternative aspects. The section of the groove T has a U-shape, but the shape of the groove T is not limited thereto. In the linear vibration motor 100, a case where the space included in the vibrator 2 is the groove T has been described. However, the form of the space is not limited to the groove and may be a through-hole (i.e., a second through-hole), to be described later, that does not open in the second direction D2.

Examples of the material for the first member 2d include low-friction materials of a polyacetal-base, a polyetheretherketone-base, a fluororesin-base, a polyester-base, or the like. Here, the low-friction material refers to a material specified in the definition described above. Note that, without being limited to the above, a Cu—C-based metal bearing material or the like may be used, for example.

The second shaft 4 is inserted into the groove T. The second shaft 4 and part of the wall determining the groove T are in contact with each other in the third direction D3 orthogonal to each of the first direction D1 and the second direction D2. Specifically, as illustrated in FIG. 4(B), at the central portion in the longitudinal direction of the groove T, that is, at the portion where the width along the third direction D3 is the shortest, at least one of the upper side wall S1 and the lower side wall S2 of the groove T in the drawing and the second shaft 4 are slidably in contact with each other.

That is, in the linear vibration motor 100, the second shaft 4 and part of the wall determining the space described above are in contact with each other at a portion where the length of the space along the third direction D3 is the shortest. As illustrated in FIG. 4(B) and FIG. 4(C), it is preferable that both of the side walls S1 and S2 be in contact with the second shaft 4.

In the linear vibration motor 100, as described above, the first shaft 3 is fitted together by insertion into the through-hole (i.e., the first through-hole) provided in the vibrator 2 extending along the first direction D1. This restricts the vibrator 2 to vibrate along the first direction D1.

Since the first member 2d has the structure described above, the second shaft 4 and the first member 2d are slidably in contact with each other as illustrated in FIG. 5. That is, even in a case where the width of the vibrator 2 is shorter than an intended width in the second direction D2, the second shaft 4 is reliably in contact with at least one of the side walls S1 and S2 of the groove T, as in FIG. 5 where the second shaft 4 is virtually illustrated by a long broken line. Therefore, the vibrator 2 does not rattle between the first shaft 3 and the second shaft 4. As a result, the vibrator 2 is configured to easily vibrate along the first direction D1.

Whereas, even in a case where the width of the vibrator 2 is longer than an intended width in the second direction D2, the vibrator 2 is can move in the second direction D2, as the second shaft 4 is virtually illustrated by a short broken line in FIG. 5. Therefore, the vibrator 2 is not excessively pressed against the first shaft 3 and the second shaft 4. As a result, unnecessary friction between the vibrator 2 and each shaft is reduced.

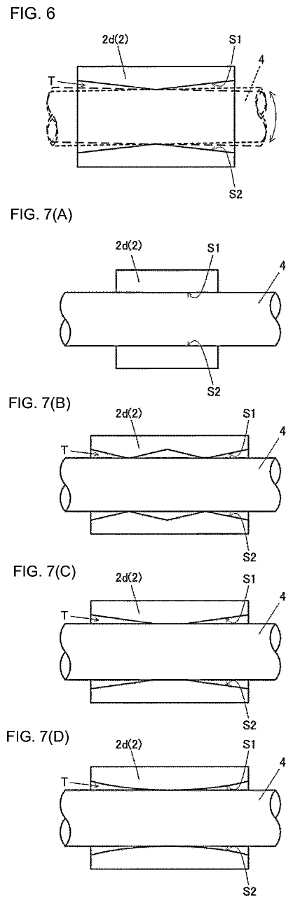

Further, in the linear vibration motor 100, as described above, the width of the groove T of the first member 2d increases from the central portion toward the one end and the other end of the groove T. The advantage of this structure will be described with reference to FIG. 6. FIG. 6 is a sectional view corresponding to FIG. 4(B), schematically illustrating a change in the state of contact between the first member 2d and the second shaft 4 when the second shaft 4 is inclined relative to the first direction D1.

Due to a problem of the accuracy of assembling the second shaft 4 into the housing 1, for example, the second shaft 4 may be inclined relative to the first direction D1, as in FIG. 6 where the second shaft 4 is virtually illustrated by a long broken line or a short broken line. With the shape of the first member 2d described above, the second shaft 4 and the first member 2d may be brought into contact with each other with a small area of the central portion of the groove T. Therefore, even when the second shaft 4 is inclined relative to the first direction D1, the vibrator 2 is not excessively pressed against the second shaft 4. As a result, excessive friction between the vibrator 2 and the second shaft 4 can be suppressed.

This structure can also suppress not only the excessive friction in the case above, but also the friction between the vibrator 2 and the second shaft 4 due to the deviation of the driving direction of the vibrator 2 from the first direction D1. As described above, when a current flows through the coil 5, Lorentz force is applied to the coil 5 by the magnetic field of the first magnet M1, and the reaction force to the Lorentz force is applied to the first magnet M1. That is, the coil 5 applies a driving force along the first direction D1 to the first magnet M1, and consequently to the vibrator 2 by energization.

However, the coil 5 is not a complete rectangle but has rounded corners, and there may be a case where a portion corresponding to each side of the rectangle is not exactly orthogonal to the first direction D1. Therefore, the direction of the reaction force to the Lorentz force that the vibrator 2 receives may slightly fluctuate from the first direction D1. As a result, as schematically illustrated in FIG. 5 and FIG. 6, the relative positional relationship between the vibrator 2 and the second shaft 4 can change during the vibration of the vibrator 2.

In a case where the first member 2d has the structure in FIG. 4, the deviation of the relative positional relationship between the vibrator 2 and the second shaft 4, caused by the fluctuation of the reaction force to the Lorentz force, can be absorbed by the effect described above. As a result, the friction between the vibrator 2 and the second shaft 4 is suppressed.

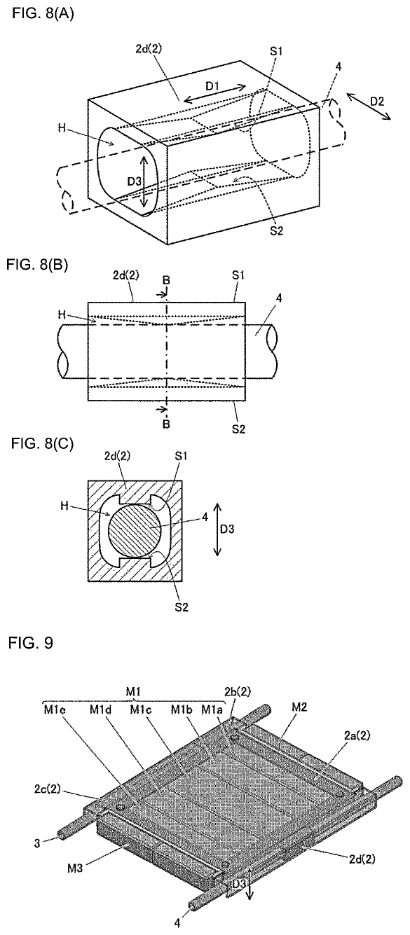

Various modifications of the first member 2d will be described with reference to FIGS. 7(a)-(d) and FIGS. 8(a)-(c). FIG. 7(A) is a front view of a first modification of the first member 2d. FIG. 7(B) is a front view of a second modification of the first member 2d. FIG. 7(C) is a front view of a third modification of the first member 2d. FIG. 7(D) is a front view of a fourth modification of the first member 2d. In these figures, the second shaft 4 is also illustrated so that the state of contact with the first member 2d may be understood.

In the first modification, the upper side wall S1 and the lower side wall S2 of the groove T in the drawing have a flat surface when viewed from the second direction D2. That is, in the first modification, the first member 2d and the second shaft 4 are in contact with each other along two lines extending in the first direction D1. Also in this case, the vibrator 2 does not rattle between the first shaft 3 and the second shaft 4, and the vibrator 2 is not excessively pressed against the first shaft 3 and the second shaft 4. Therefore, the vibrator 2 is configured to easily vibrate along the first direction D1, and unnecessary friction between the vibrator 2 and each shaft can be reduced.

In the second modification, the upper side wall S1 and the lower side wall S2 of the groove T in the drawing have a saw-tooth shape when viewed from the second direction D2. That is, in the second modification, the first member 2d and the second shaft 4 are in contact with each other in a minute region. Therefore, in the second modification, slidability is higher than that of the first modification. In the second modification, the first member 2d and the second shaft 4 are in contact with each other at four portions, but the number of contact portions is not limited thereto. Also in this case, the vibrator 2 may be made to easily vibrate along the first direction D1, and unnecessary friction between the vibrator 2 and each shaft may be reduced.

In the third modification, the upper side wall S1 and the lower side wall S2 of the groove T in the drawing have a trapezoidal shape when viewed from the second direction D2. That is, in the third modification, the first member 2d and the second shaft 4 are in contact with each other along two lines extending in the first direction D1. Note that, in the third modification, the two lines serving as the contact portions are shorter than those in the first modification. Therefore, in the third modification, slidability is higher than that of the first modification. Also in this case, the vibrator 2 may be made to easily vibrate along the first direction D1, and unnecessary friction between the vibrator 2 and each shaft may be reduced.

In the fourth modification, the upper side wall S1 and the lower side wall S2 of the groove T in the drawing have an arc shape when viewed from the second direction D2. That is, in the fourth modification, the first member 2d and the second shaft 4 are in contact with each other in a minute region. Therefore, in the fourth modification, slidability is higher than that of the first modification. Also in this case, the vibrator 2 may be made to easily vibrate along the first direction D1, and unnecessary friction between the vibrator 2 and each shaft is also reduced.

Further, in the fourth modification, the deviation of the relative positional relationship between the vibrator 2 and the second shaft 4, caused by the inclination of the second shaft 4 relative to the first direction D1 and the fluctuation of the reaction force to the Lorentz force, may be absorbed.

FIG. 8(A) is a perspective view of a fifth modification of the first member 2d. FIG. 8(B) is a front view of the fifth modification of the first member 2d. FIG. 8(C) is a sectional view of the fifth modification of the first member 2d in the direction of arrows, taken along a plane including a line B-B in FIG. 8(B) and being orthogonal to the first direction D1. In these figures, the second shaft 4 is also illustrated so that the state of contact with the first member 2d may be understood.

In the fifth modification of the first member 2d, a through-hole H (second through-hole) penetrating through the first member 2d along the first direction D1 is formed in the first member 2d. That is, also in the fifth modification, the vibrator 2 has a space on the other side surface side extending along the first direction D1. The length of the space becomes longer along the third direction D3 from the inside toward the one end and the other end. That is, in the fifth modification of the first member 2d, protrusions of which heights increase from one end and the other end toward the central portion of the through-hole H are provided in the through-hole H. The shape of the through-hole H is not limited to the shape illustrated in FIG. 8(B), for example.

Also in the fifth modification, as illustrated in FIG. 8(B), at the central portion in the longitudinal direction of the groove T, at least one of the upper side wall S1 and the lower side wall S2 of the through-hole H in the drawing and the second shaft 4 are slidably in contact with each other. That is, also in the linear vibration motor 100 in which the fifth modification of the first member 2d is used, the second shaft 4 and part of the wall determining the space described above are in contact with each other, at a portion where the length of the space along the third direction D3 is the shortest. As illustrated in FIG. 8(B) and FIG. 8(C), it is preferable that both of the side walls S1 and S2 be in contact with the second shaft 4.

Also in the fifth modification, similar to the example of the first member 2d in FIG. 3, the vibrator 2 may be made to easily vibrate along the first direction D1, and unnecessary friction between the vibrator 2 and each shaft may be reduced. Further, in the fifth modification, the deviation of the relative positional relationship between the vibrator 2 and the second shaft 4, caused by the inclination of the second shaft 4 relative to the first direction D1 and the fluctuation of the reaction force to the Lorentz force, may be absorbed.

FIG. 9 is a perspective view of the vibrator 2 including a sixth modification of the first member 2d. In FIG. 9, the first shaft 3 and the second shaft 4 are also illustrated so that the state of engagement between the vibrator 2 and the first shaft 3, and between the vibrator 2 and the second shaft 4 may be understood.

In the sixth modification of the first member 2d, the first member 2d is a sleeve that has the same shape and is made of the same material as those of the first sleeve 2b and the second sleeve 2c. The first sleeve 2b and the second sleeve 2c are fitted into a groove provided on one side surface side of the substrate 2a along the first direction D1, and the first member 2d is fitted into a groove provided on the other side surface side of the substrate 2a along the first direction D1. In FIG. 9, each groove provided in the substrate 2a is open to the lower side in the drawing in the third direction D3. Therefore, the first sleeve 2b, the second sleeve 2c, and the first member 2d in the respective grooves, and the first shaft 3 and the second shaft 4 are naturally invisible, but are illustrated in a see-through state.

As described above, the first shaft 3 is slidably fitted together by insertion into the first sleeve 2b and the second sleeve 2c. Whereas the second shaft 4 is slidably fitted together by insertion into the first member 2d that is a sleeve having the same shape and the same material as those of the first sleeve 2b and the second sleeve 2c. Here, the first member 2d is fitted into the groove on the other side surface side of the substrate 2a, such that the first member 2d configured to be inclined in the third direction D3 when external force is applied.

As described above, it is possible that the second shaft 4 becomes inclined relative to the first direction D1 due to a problem of the accuracy of assembling the second shaft 4 into the housing 1. Here, it is assumed that the first member 2d is fitted into the groove on the other side surface side of the substrate 2a such that the first member 2d may be inclined. In the case above, even when the second shaft 4 is inclined relative to the first direction D1, the first member 2d is inclined in accordance with the inclination of the second shaft 4, by the force generated when the vibrator 2, into which the first shaft 3 and the second shaft 4 are fitted together by insertion, is attached to the housing 1. As a result, the vibrator 2 is not excessively pressed against the second shaft 4. Further, as a result, excessive friction between the vibrator 2 and the second shaft 4 is suppressed.

In the description above, a case where each groove provided to the substrate 2a opens in the third direction D3 has been described. However, when each of the grooves opens in the second direction D2, the first member 2d may be inclined in the second direction D2. That is, in this case, the first member 2d is inclined in accordance with the inclination of the second shaft 4 relative to the second direction D2, and the excessive friction between the vibrator 2 and the second shaft 4 may similarly be suppressed.

First Modification of Schematic Form of Linear Vibration Motor—

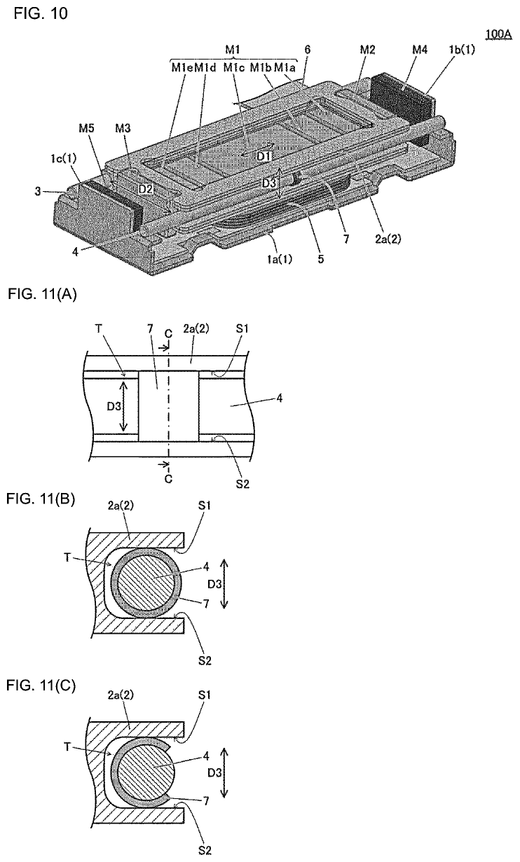

A linear vibration motor 100A that is a first modification of the linear vibration motor 100 being a schematic form of the linear vibration motor according to the present disclosure, will be described with reference to FIG. 10 and FIGS. 11(a)-(c).

FIG. 10 is a perspective view of the linear vibration motor 100A that is the first modification of the linear vibration motor 100, corresponding to FIG. 3. FIG. 11(A) is a front view of a second member 7 in the linear vibration motor 100A. FIG. 11(B) is a sectional view of the second member 7 in the direction of arrows, taken along a plane including a line C-C in FIG. 11(A) and being orthogonal to the first direction D1. FIG. 11(C) is a sectional view of the first modification of the second member 7 in the direction of arrows in the linear vibration motor 100A, corresponding to FIG. 11(B). In FIGS. 11(a)-(c), the second shaft 4 is also illustrated to indicate the state of contact with the first member 2d.

The linear vibration motor 100A differs from the linear vibration motor 100 in the manner of engagement between the vibrator 2 and the second shaft 4. Since other configurations are basically the same as those of the linear vibration motor 100 described above, repetitive description will be omitted.

In the linear vibration motor 100A, the second member 7 containing a low-friction material is provided in a cylindrical shape at the central portion of the second shaft 4. Further, on the other side surface of the substrate 2a of the vibrator 2, there is formed a groove T that opens in the second direction D2, has a depth larger than the diameter of the second shaft 4, and extends along the first direction D1. That is, in the linear vibration motor 100A, the groove T corresponds to the space extending along the first direction D1.

The second shaft 4 and part of the wall determining the groove T are in contact with each other in the third direction D3. Specifically, as illustrated in FIG. 11(B), at the central portion in the longitudinal direction of the groove T, at least one of the upper side wall S1 and the lower side wall S2 of the groove T in the drawing and the second shaft 4 are slidably in contact with each other via the second member 7. As illustrated in FIG. 11(B), both of the side walls S1 and S2 are preferably in contact with the second member 7.

For the second member 7, low-friction materials of a polyacetal-base, a polyetheretherketone-base, a fluororesin-base, a polyester-base, or the like may be used, for example. Here, the low-friction material is specified in the definition described in the description of the material used for the first member 2d.

As further shown, the second member 7 has a cylindrical shape in FIG. 10, FIG. 11(A), and FIG. 11(B), but it is noted that the shape of the second member 7 is not limited thereto. That is, it is sufficient that the second member 7 has a shape in which at least one of the upper side wall S1 and the lower side wall S2 of the groove T and the second shaft 4 are indirectly and slidably in contact with each other. For example, as illustrated in FIG. 11(C), the second member 7 may have a shape with a portion that cannot come into contact with the groove T removed. Further, the position where the second member 7 is provided is not limited to the central portion of the second shaft 4. Furthermore, a plurality of second members 7 may be provided to the second shaft 4. The width of the second member 7 in the first direction D1 is preferably equal to or less than 2 mm.

Also, in the linear vibration motor 100A, the vibrator 2 does not rattle between the first shaft 3 and the second shaft 4, and the vibrator 2 is not excessively pressed against the first shaft 3 and the second shaft 4. Therefore, the vibrator 2 can be configured to easily vibrate along the first direction D1, and unnecessary friction between the vibrator 2 and each shaft is reduced. Further, since the number of components is reduced as compared with the linear vibration motor 100, assembling accuracy and the efficiency of assembling work may be improved.

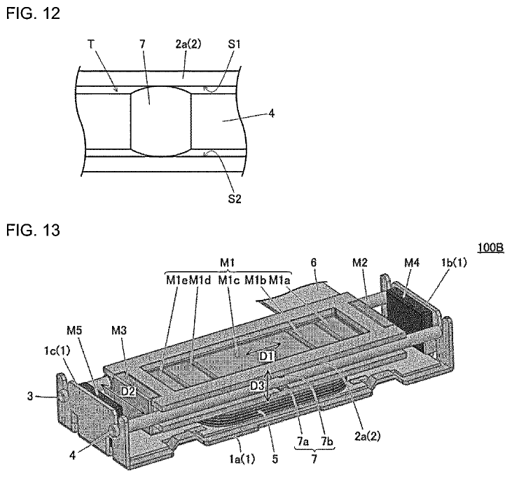

A second modification of the second member 7 in the linear vibration motor 100A will be described with reference to FIG. 12. FIG. 12 is a front view of the second modification of the second member 7.

Also in the second modification, the second member 7 containing a low-friction material is provided to the central portion of the second shaft 4. It is noted that the outer shape of the second member 7 of the second modification is a barrel shape extending along the first direction D1. That is, the second member 7 has a cylindrical shape in which the sectional area decreases from the central portion toward one end and the other end of the second member 7. Also, in the second modification, the position where the second member 7 is provided is not limited to the central portion of the second shaft 4. Further, a plurality of second members 7 may be provided to the second shaft 4.

As shown in the second modification, the second member 7 and the second shaft 4 are in contact with each other in a minute region. Therefore, in the second modification, slidability is higher than that of the second member 7 in a cylindrical shape. Also in this case, the vibrator 2 may be made to easily vibrate along the first direction D1, and unnecessary friction between the vibrator 2 and each shaft may be reduced.

Further, in the second modification, the deviation of the relative positional relationship between the vibrator 2 and the second shaft 4, caused by the inclination of the second shaft 4 relative to the first direction D1 and the fluctuation of the reaction force to the Lorentz force, may be absorbed.

Second Modification of Schematic Form of Linear Vibration Motor—

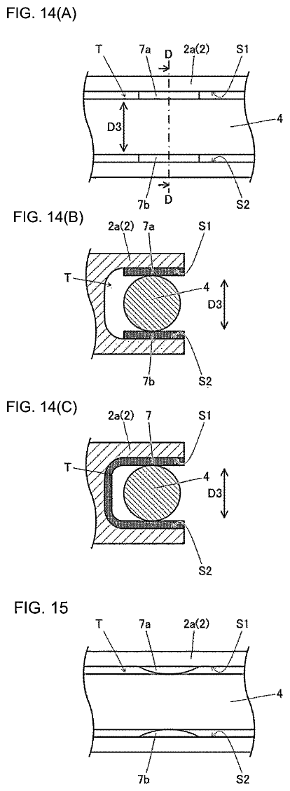

A linear vibration motor 100B that is a second modification of the linear vibration motor 100 being a schematic form of the linear vibration motor according to the present disclosure, will be described with reference to FIG. 13 and FIGS. 14(a)-(c).

FIG. 13 is a perspective view of the linear vibration motor 100B that is the second modification of the linear vibration motor 100, corresponding to FIG. 3. FIG. 14(A) is a front view of the second member 7 in the linear vibration motor 100B. FIG. 14(B) is a sectional view of the second member 7 in the direction of arrows, taken along a plane including a line D-D in FIG. 14(A) and being orthogonal to the first direction D1. FIG. 14(C) is a sectional view of a first modification of the second member 7 in the direction of arrows in the linear vibration motor 100B, corresponding to FIG. 14(B).

Similar to the linear vibration motor 100A, the linear vibration motor 100B differs from the linear vibration motor 100 in the manner of engagement between the vibrator 2 and the second shaft 4. Since other configurations are basically the same as those of the linear vibration motor 100, repetitive description will be omitted.

Similar to the linear vibration motor 100A, also in the linear vibration motor 100B, on the other side surface of the substrate 2a of the vibrator 2, there is formed a groove T that opens in the second direction D2, has a depth larger than the diameter of the second shaft 4, and extends along the first direction D1. That is, also in the linear vibration motor 100B, the groove T corresponds to the space extending along the first direction D1.

The second member 7 containing a low-friction material is provided to the central portion in the longitudinal direction of the groove T. In the linear vibration motor 100B, the second member 7 includes two plate-shaped members 7a and 7b facing each other in the third direction D3. The plate-shaped member 7a is provided to the upper side wall S1 and the plate-shaped member 7b is provided to the lower side wall S2 in the drawing.

The second shaft 4 and part of the wall determining the groove T are in contact with each other in the third direction D3. Specifically, as illustrated in FIG. 14(B), at the central portion in the longitudinal direction of the groove T, at least one of the upper side wall S1 and the lower side wall S2 of the groove T in the drawing and the second shaft 4 are slidably in contact with each other via the second member 7. As illustrated in FIG. 14(B), both of the plate-shaped members 7a and 7b are preferably in contact with the second shaft 4.

For the second member 7 in the linear vibration motor 100B, low-friction materials of a polyacetal-base, a polyetheretherketone-base, a fluororesin-base, a polyester-base, and the like may be used, for example. Here, the low-friction material is specified in the definition described in the description of the material used for the first member 2d.

In FIG. 13, FIG. 14(A), and FIG. 14(B), when viewed from the second direction D2, the second member 7 is the two plate-shaped members 7a and 7b that are disposed so as to face each other with the second shaft 4 interposed therebetween, but is not limited thereto. For example, the second member 7 may include a plurality of pairs of two plate-shaped members having the positional relationship described above along the first direction D1. For purposes of this disclosure, it is noted that “two plate-shaped members face each other” means that the two plate-shaped members at least partially overlap with each other when viewed from the third direction D3. That is, it is sufficient that the second member 7 has a form in which at least one of the upper side wall S1 and the lower side wall S2 of the groove T and the second shaft 4 are indirectly and slidably in contact with each other.

For example, as illustrated in FIG. 14(C), the second member 7 may have a U-shape in which the plate-shaped members 7a and 7b are connected to each other at the bottom of the groove T. Further, the position where the second member 7 is provided is not limited to the central portion in the longitudinal direction of the groove T. The width of the second member 7 in the first direction D1 is preferably equal to or less than 2 mm.

Also, in the linear vibration motor 100B, the vibrator 2 does not rattle between the first shaft 3 and the second shaft 4, and the vibrator 2 is not excessively pressed against the first shaft 3 and the second shaft 4. Therefore, the vibrator 2 may be made to easily vibrate along the first direction D1, and unnecessary friction between the vibrator 2 and each shaft may be reduced. Further, since the second member 7 is provided to the groove T side, assembling accuracy and the efficiency of assembling work may be improved.

A second modification of the second member 7 in the linear vibration motor 100B will be described with reference to FIG. 15. FIG. 15 is a front view of the second modification of the second member 7.

In the second modification, the section of the plate-shaped members 7a and 7b is bow-shaped when viewed from the second direction D2. The plate-shaped members 7a and 7b may have a plate-shape of which section orthogonal to the second direction D2 is an arc-shape, or a disk-shape of which any section parallel to the third direction D3 is an arc-shape, for example.

In the second modification, the second member 7 and the second shaft 4 are in contact with each other in a minute region. Therefore, in the second modification, slidability is higher than that of the second member 7 in a cylindrical shape. Also in this case, the vibrator 2 may be made to easily vibrate along the first direction D1, and unnecessary friction between the vibrator 2 and each shaft may be reduced.

Further, in the second modification, the deviation of the relative positional relationship between the vibrator 2 and the second shaft 4, caused by the inclination of the second shaft 4 relative to the first direction D1 and the fluctuation of the reaction force to the Lorentz force, may be absorbed.

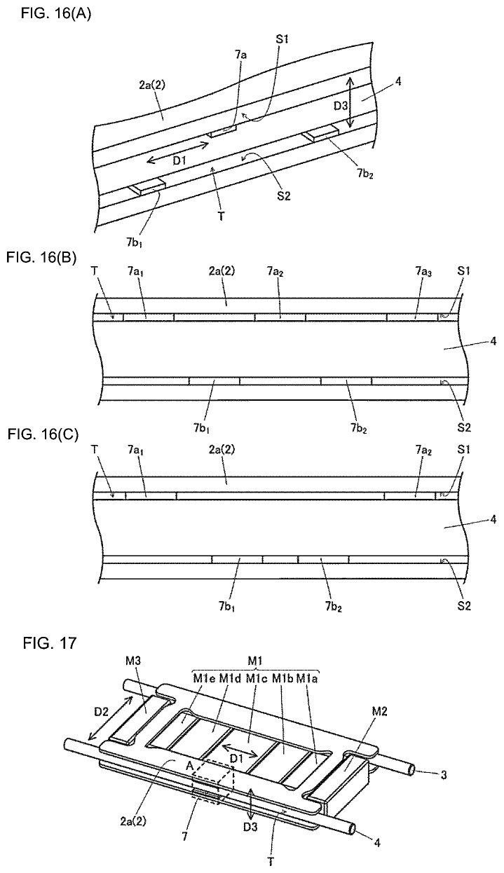

A third modification of the second member 7 in the linear vibration motor 100B will be described with reference to FIGS. 16(A)-(C). In particular, FIG. 16(A) is a perspective view of the third modification of the second member 7 in the linear vibration motor 100B. FIG. 16(B) is a front view of another form of the third modification of the second member 7. FIG. 16(C) is a front view of still another form of the third modification of the second member 7.

In the third modification, the second member 7 includes three plate-shaped members 7a, 7b₁, and 7b₂. The plate-shaped member 7a is provided to the upper side wall S1 of the groove T in the drawing, and the plate-shaped members 7b₁ and 7b₂ are provided to the lower side wall S2 with a distance therebetween. That is, when viewed from the second direction D2, the three plate-shaped members 7b₁, 7a, and 7b₂ are disposed at positions of apexes of a triangle that are shifted from each other in the first direction D1 with the second shaft 4 interposed therebetween. It is noted that the plate-shaped member provided to the upper side wall S1 and the plate-shaped member provided to the lower side wall S2 may partially overlap with each other in an exemplary aspect.

In the third modification, when viewed from the third direction D3, the plate-shaped member 7a is disposed at the center of the distance between the plate-shaped member 7b₁ and the plate-shaped member 7b₂, but is not limited thereto in alternative aspects. The second member 7 may further include another plate-shaped member. For example, as illustrated in FIG. 16(B), the second member 7 may be disposed in a zigzag manner with the second shaft 4 interposed therebetween. Further, as illustrated in FIG. 16(C), when viewed from the third direction D3, a plurality of plate-shaped members provided to the lower side wall S2 may be disposed between two plate-shaped members provided to the upper side wall S1 of the groove T. With regard to the positions where the plate-shaped members are placed, the upper side wall S1 and the lower side wall S2 may be reversed with respect to the description above.

It is also noted that the number of plate-shaped members provided to each of the upper side wall S1 and the lower side wall S2 is not particularly limited. That is, when viewed from the second direction D2, it is sufficient that the plate-shaped member provided to the upper side wall S1 and the plate-shaped member provided to the lower side wall S2 of the groove T is disposed at positions shifted from each other in the first direction D1 with the second shaft 4 interposed therebetween.

Also, in the linear vibration motor 100B including the second member 7 of the third modification, the vibrator 2 can be configured to easily vibrate along the first direction D1, and unnecessary friction between the vibrator 2 and each shaft may be reduced.

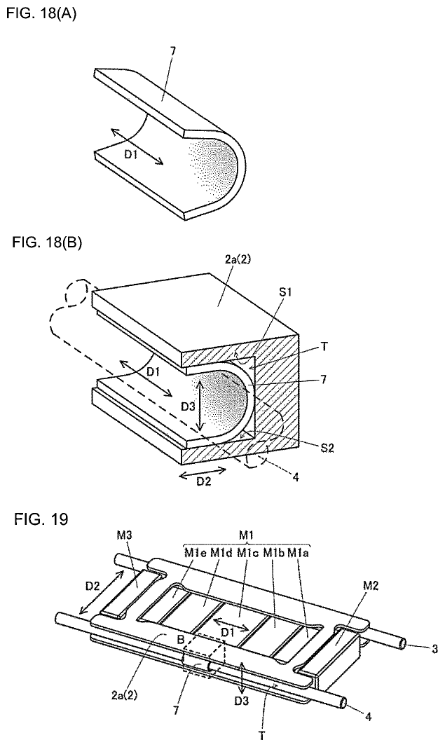

A fourth modification of the second member 7 in the linear vibration motor 100B will be described with reference to FIG. 17 and FIGS. 18(A)-(B). FIG. 17 is a perspective view of the vibrator 2 in a state that the fourth modification of the second member 7 in the linear vibration motor 100B is fitted into the groove T formed on the other side surface of the substrate 2a. FIG. 18(A) is a perspective view of the fourth modification of the second member 7. FIG. 18(B) is an enlarged view of a dotted line portion A in FIG. 17, and is a perspective view of a state that the fourth modification of the second member 7 is fitted into the groove T formed on the other side surface of the substrate 2a. In FIG. 18(B), the second shaft 4 is also illustrated so that the state of contact with the second member 7 may be understood.

In the fourth modification, the second member 7 is a member of which section orthogonal to the first direction D1 is a U-shape when fitted into the groove T of the substrate 2a. Here, the distance between one end and the other end of the second member 7 in the section before being fitted into the groove T is wider than that after being fitted into the groove T. That is, the second member 7 is elastically deformed when fitted into the groove T, and comes into contact with the upper side wall S1 and the lower side wall S2 of the groove T in the drawing. This configuration enables the second member 7 to be fixed in the groove T. FIG. 17 illustrates a case where the second member 7 is disposed at the central portion in the longitudinal direction of the groove T.

The second shaft 4 is, in the third direction D3, slidably in contact with at least one of the portion contacting with the upper side wall S1 and the portion contacting with the lower side wall S2 of the groove T in the U-shaped second member 7. It is noted that as illustrated in FIG. 18(B), it is preferable that both of the portions described above in the second member 7 and the second shaft 4 be in contact with each other.

Examples of the material for the second member 7 according to the fourth modification include stainless steel such as SUS304, phosphor bronze, and a resin material of a polyacetal-base or the like. Metal materials such as stainless steel and phosphor bronze have high strength, and a resin material of a polyacetal-base or the like has a low dynamic friction coefficient as described above. Note that, the slidability may be improved by coating the surface of a metal material such as stainless steel or phosphor bronze with a film of a resin material such as polytetrafluoroethylene.

In the fourth modification, the second member 7 is disposed at the central portion in the longitudinal direction of the groove T, but is not limited thereto. Further, a plurality of second members 7 may be disposed in the groove T. The width of the second member 7 in the first direction D1 is preferably equal to or less than 2 mm.

Also, in the linear vibration motor 100B including the second member 7 of the fourth modification, the vibrator 2 may be made to easily vibrate along the first direction D1, and unnecessary friction between the vibrator 2 and each shaft may be reduced.

Further, when the material is a metal, the fourth modification of the second member 7 may be manufactured only by cutting a bent thin plate-shaped metal member. Therefore, the height along the third direction D3 when fitted into the groove T of the substrate 2a may be suppressed, and consequently, the thickness of the vibrator 2 may be reduced. Whereas, when the material is a resin, a molded article with a predetermined shape may be manufactured in advance by molding or the like. Therefore, the form accuracy of the second member 7 may be increased, and consequently, the variation in friction between the vibrator 2 and each shaft may be reduced. In the fourth modification, the second member 7 is fixed by being fitted into the groove T of the substrate 2a regardless of the material thereof. This configuration makes it easy to assemble the vibrator 2 and the manufacturing cost may be reduced.

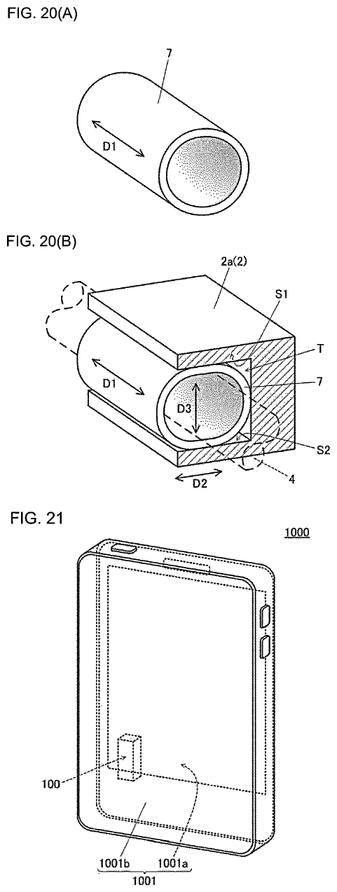

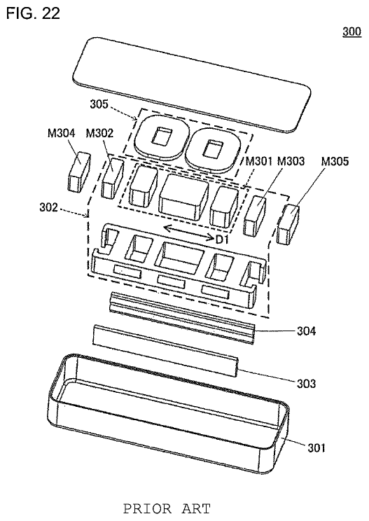

A fifth modification of the second member 7 in the linear vibration motor 100B will be described with reference to FIG. 19 and FIGS. 20(A)-(B). FIG. 19 is a perspective view of the vibrator 2 in a state that the fifth modification of the second member 7 in the linear vibration motor 100B is fitted into the groove T formed on the other side surface of the substrate 2a. FIG. 20(A) is a perspective view of the fifth modification of the second member 7. FIG. 20(B) is an enlarged view of a dotted line portion B in FIG. 19, and is a perspective view of a state that the fifth modification of the second member 7 is fitted into the groove T formed on the other side surface of the substrate 2a. In FIG. 20(B), the second shaft 4 is also illustrated so that the state of contact with the second member 7 may be understood.

In the fifth modification, the second member 7 is a cylindrical member of which section orthogonal to the first direction D1 is an oval shape when fitted into the groove T of the substrate 2a. Here, the oval shape includes an oblong shape, an elliptical shape, an ovoid shape and the like. The width of the section along the third direction D3 before being fitted into the groove T is wider than that after being fitted into the groove T. That is, the second member 7 is elastically deformed when fitted into the groove T, and comes into contact with the upper side wall S1 and the lower side wall S2 of the groove T in the drawing. This configuration enables the second member 7 to be fixed in the groove T. FIG. 19 illustrates a case where the second member 7 is disposed at the central portion in the longitudinal direction of the groove T.

The second shaft 4 is, in the third direction D3, slidably in contact with at least one of the portion contacting with the upper side wall S1 and the portion contacting with the lower side wall S2 of the groove T in the cylindrical second member 7. It is also noted that as illustrated in FIG. 20(B), it is preferable that both of the portions in the second member 7 described above and the second shaft 4 be in contact with each other. As the material of the second member 7 according to the fifth modification, the same material as that of the fourth modification may be used.

Also in the fifth modification, the second member 7 may be disposed at any portion in the longitudinal direction of the groove T. Further, the plurality of second members 7 may be disposed in the groove T. The width of the second member 7 in the first direction D1 is preferably equal to or less than 2 mm.

Also, in the linear vibration motor 100B including the second member 7 of the fifth modification, the vibrator 2 may be made to easily vibrate along the first direction D1, and unnecessary friction between the vibrator 2 and each shaft may be reduced.

Further, when the material is a metal, the fifth modification of the second member 7 may also be manufactured only by cutting a thin cylindrical member. Therefore, the height of the fifth modification of the second member 7 along the third direction D3 when fitted into the groove T of the substrate 2a may be suppressed, and consequently, the thickness of the vibrator 2 may be reduced. Whereas, when the material is a resin, a molded article with a predetermined shape may be manufactured in advance by extrusion molding or the like. Therefore, the form accuracy of the second member 7 may be increased, and consequently, the variation in friction between the vibrator 2 and each shaft may be reduced. Further, also in the fifth modification, the second member 7 is fixed by being fitted into the groove T of the substrate 2a regardless of the material thereof. This makes it easy to assemble the vibrator 2. Further, the manufacturing cost may be reduced.

Schematic Form of Electronic Apparatus—

A portable information terminal 1000 shown a schematic form of an electronic apparatus using the linear vibration motor according to the present disclosure will be described with reference to FIG. 21.

FIG. 21 is a transparent perspective view of the portable information terminal 1000. As shown, the portable information terminal 1000 includes an apparatus housing 1001; the linear vibration motor 100 according to the present disclosure as described above; and an electronic circuit (not illustrated) related to transmission and reception, and information processing. The apparatus housing 1001 includes a first portion 1001a and a second portion 1001b. The first portion 1001a is a display and the second portion 1001b is a frame. The linear vibration motor 100 is accommodated in the apparatus housing 1001.

In the portable information terminal 1000, the linear vibration motor 100 according to the present disclosure is used as a vibration generator for skin sensory feedback or for confirming a key operation, an incoming call, or the like by vibration. The linear vibration motor used in the portable information terminal 1000 is not limited to the linear vibration motor 100, and may be any linear vibration motor according to the present disclosure.

With the linear vibration motor according to exemplary aspect of the present disclosure, as described above, a vibrator is configured to easily vibrate in one direction, and unnecessary friction between the vibrator and a guide fixed to the housing is reduced. Therefore, the portable information terminal 1000 is able to generate vibration sufficient for skin sensory feedback and confirmation of a key operation, an incoming call, or the like.

In the linear vibration motor according to the present disclosure, as a mechanism for transferring the vibration of the vibrator 2 to the housing 1, a magnetic spring mechanism achieved by a pair of the second magnet M2 and the fourth magnet M4 and a pair of the third magnet M3 and the fifth magnet M5 has been described, but the mechanism for transferring the vibration of the vibrator 2 to the housing 1 is not limited thereto. For example, instead of the magnetic spring mechanism, a mechanical spring mechanism, such as a coil spring or a plate spring, can be used.

As an example of a schematic form of an electronic apparatus in which the linear vibration motor according to the present disclosure is used, a portable information terminal provided with a display is described, but the electronic apparatus is not limited thereto. The electronic apparatus according to the present disclosure need not include a display.

Examples of the electronic apparatus according to the present disclosure include mobile phones, smartphones, portable video game machines, video game machine controllers, virtual reality (VR) device controllers, smart watches, tablet type personal computers, notebook type personal computers, remote controllers used to operate televisions, or the like, touch panel displays for automatic teller machines, or the like, various toys, and the like.

In general, it is noted that the exemplary embodiments disclosed in this description are illustrative, and the invention according to the present disclosure is not limited to the embodiments and modifications described above. Various applications and modifications can be added within the range described above.

The invention according to the present disclosure is applied to a linear vibration motor used as a vibration generator for skin sensory feedback, or for confirming a key operation, an incoming call, or the like by vibration in an electronic apparatus, for example. The skin sensory feedback includes expressing a tactile image corresponding to an action in a video game (such as opening and closing of a door, operation of a steering wheel of an automobile, for example) by vibration of a controller, for example. Note that, the skin sensory feedback may be other than the above.

In general, it is also noted that the present invention may also be applied to a linear vibration motor used as an actuator of a robot or the like, for example.

### REFERENCE SIGNS LIST

100 LINEAR VIBRATION MOTOR
1 HOUSING
2 VIBRATOR
2d FIRST MEMBER
3 FIRST SHAFT
4 SECOND SHAFT
5 COIL
6 EXTENDED WIRING MEMBER
7 SECOND MEMBER
D1 FIRST DIRECTION
D2 SECOND DIRECTION
D3 THIRD DIRECTION
M1 FIRST MAGNET

1. A linear vibration motor, comprising:
a housing;
a vibrator disposed in the housing, configured to vibrate along a first direction, and having a first through-hole and a space that each extend along the first direction; and
a first shaft and a second shaft that each extend along a second direction, and that each are fixed to the housing to support the vibrator slidably along the first direction,
wherein the first shaft is disposed in the first through-hole and the second shaft is disposed in the space, and
wherein the second shaft is in contact with a part of a wall defining the space in a third direction that is orthogonal to each of the first direction and the second direction.

2. The linear vibration motor according to claim 1, wherein the space is either a groove or a second through-hole disposed in the vibrator.

3. The linear vibration motor according to claim 2, wherein the vibrator includes a first member, and the groove or the second through-hole is disposed in the first member.

4. The linear vibration motor according to claim 2, wherein a sectional area of the space increases from a central portion toward opposing ends in the first direction, and the second shaft is in contact with a part of the wall defining the space at the central portion of the space in the first direction.

5. The linear vibration motor according to claim 2, wherein a first magnet is disposed in a through-hole extending in a central portion of the vibrator, and the first magnet opposes a coil fixed to the housing for applying a driving force to the first magnet, such that the vibrator is configured to vibrate along the first direction.

6. The linear vibration motor according to claim 5, wherein the vibrator further comprises a second magnet and a third magnet disposed on opposing sides of the vibrator with the first magnet disposed therebetween.

7. The linear vibration motor according to claim 6, further comprising:
a fourth magnet fixed to a first side surface of the housing to oppose the second magnet, such that the respective magnets repel each other; and
a fifth magnet fixed to a second side surface of the housing to oppose the third magnet, such that the respective magnets repel each other.

8. The linear vibration motor according to claim 1, wherein the space in the vibrator that extends along the first direction comprises a groove opening in the second direction that is deeper than a diameter of the second shaft and that extends along the first direction.

9. A linear vibration motor, comprising:
a housing;
a vibrator disposed in the housing, configured to vibrate along a first direction, and having a first through-hole and a space that each extend along the first direction; and
a first shaft and a second shaft extending in a second direction, and that are each fixed to the housing to support the vibrator slidably along the first direction,
wherein the first shaft is disposed in the first through-hole, and the second shaft is disposed in the space, and
wherein the second shaft is in contact with a part of a wall that defines the space, with a second member containing a low-friction material being disposed therebetween in a third direction that is orthogonal to each of the first direction and the second direction.

10. The linear vibration motor according to claim 9, wherein the low-friction material exhibits a dynamic friction coefficient of 0.15 or less relative to carbon steel in a thrust type dynamic friction coefficient.

11. The linear vibration motor according to claim 9, wherein the second member is coupled to at least part of a side surface of the second shaft.

12. The linear vibration motor according to claim 11, wherein the second member is cylindrically disposed to the side surface of the second shaft.

13. The linear vibration motor according to claim 9, wherein the second member is coupled to a part of the wall defining the space.

14. The linear vibration motor according to claim 13, wherein the second member includes two plate-shaped members facing each other with the second shaft disposed therebetween when viewed from the second direction.

15. The linear vibration motor according to claim 13, wherein the second member includes three plate-shaped members disposed at positions shifted from each other in the first direction with the second shaft disposed therebetween when viewed from the second direction.

16. The linear vibration motor according to claim 9, wherein the second member comprises a section orthogonal to the first direction that has a U-shape.

17. The linear vibration motor according to claim 9, wherein the second member is a cylindrical member having an oval shaped section that is orthogonal to the first direction.

18. The linear vibration motor according to claim 9, wherein the vibrator includes at least one first magnet, and a coil is fixed to the housing for applying a driving force to the first magnet, such that the vibrator is configured to vibrate along the first direction.

19. The linear vibration motor according to claim 18,
wherein the vibrator includes a second magnet and a third magnet,
wherein a fourth magnet and a fifth magnet are fixed to the housing,
wherein the second to fifth magnets are arrayed, such that the second to fifth magnets at least partially overlap with each other when viewed from the first direction, the second magnet and the fourth magnet face each other, and the third magnet and the fifth magnet face each other,
wherein the second magnet and the fourth magnet are disposed such that array directions of respective magnetic poles are parallel to each other and the second magnet and the fourth magnet repel each other, and
wherein the third magnet and the fifth magnet are disposed such that array directions of respective magnetic poles are parallel to each other and the third magnet and the fifth magnet repel each other.

20. An electronic apparatus, comprising:
the linear vibration motor according to claim 1 and an apparatus housing, with the linear vibration motor being accommodated in the apparatus housing.
